(19) United States
(12) Patent Application Publication
(10) Pub. No.: US 2010/0164958 A1
(43) Pub. Date: Jul. 1, 2010

(54) DISPLAY METHOD OF ON SCREEN DISPLAY (OSD) AND DISPLAY SYSTEM THEREOF

(75) Inventor: Chou-Liang Tsai, Tainan County (TW)

Correspondence Address: J C PATENTS, 4 VENTURE, SUITE 250, IRVINE, CA, 92618, US

(73) Assignee: HIMAX TECHNOLOGIES LIMITED, Tainan County (TW)

(21) Appl. No.: 12/345,272

(22) Filed: Dec. 29, 2008

(51) Int. Cl. G06T 1/60; G06T 11/00

(52) U.S. Cl. 345/467; 345/530

(57) ABSTRACT

A display method of an OSD and a display system are provided herein. In the display method, a plurality of symbols are respectively compressed into a plurality of codewords according to an encoding process, and the codewords are stored in a memory module. A plurality of index values respectively corresponding to the symbols are established in a codebook and the codebook is stored in the memory module, wherein the index values are address information of storing the codewords in the memory module. The index value corresponding to a designation symbol of the symbols is searched out from the codebook according to an input command corresponding to the designation symbol, and a decoding process is performed on the codeword corresponding to the designation symbol from the memory module for displaying the designation symbol on the display. Therefore, a storage space of the memory module is reduced by compressing the symbols.

### BACKGROUND OF THE INVENTION

1. Field of Invention

The present invention relates to a display method of an on screen display (OSD) and a display system thereof, and more particular, to a method and a system that have a process of compressing the symbol of the OSD for displaying the symbol.

2. Description of the Related Art

An on screen display (OSD) is an image superimposed on a picture of a screen, which is now applied to apparatus, such as televisions, liquid crystal displays, and etc. in widespread use for displaying various additional messages on the screen, such as a user interface showing adjustable control parameters of a display device.

Generally, there are two display manners of the OSD, i.e. bitmap-based and font-based. In the bitmap-based display manner, a displayed image represented by pixels is stored in a memory. The bitmap-based display manner has better color performance, but repeated information included in the displayed image, e.g. a plurality of identical letters, would consume a storage space of the memory. In the font-based display manner, fonts, which may be used repeatedly, such as letters in English alphabet and punctuation marks, are stored in the memory, and a displayed information is superimposed on the screen picture by piecing the needed fonts together.

In both of the bitmap-based display manner and the font-based display manner, the displayed image or the displayed font is stored in the memory pro address. When a certain image or font is displayed, operation resource is consumed for calculating address of storing the image or font in the memory, and thus, the image or the font can not be displayed in real time. In addition, data of the images or fonts are considerably large, and the cost is increased since the memory with large storage space is needed. Therefore, in consideration of cost-benefit, the display method of the OSD should be improved.

### SUMMARY OF THE INVENTION

The invention provides a display method of an on screen display (OSD) and a display system that can reduce a memory of storing the OSD data, and increase an efficiency of displaying the OSD data.

A display method of the OSD is provided in the present invention. First, a plurality of symbols of the OSD is compressed into a plurality of codewords according to a first encoding process, and the codewords are stored in a memory module. In addition, a plurality of index values corresponding to the symbols are establish in a codebook, and the codebook is stored in the memory module, wherein the index values are address information of storing the codewords in the memory module. Next, the index value corresponding to a designation symbol of the symbols is searched out from the codebook according to an input command corresponding to the designation symbol, and a first decoding process corresponding to the first encoding process is performed on the codeword corresponding to the designation symbol, which is searched from the memory module according to the searched index value, for displaying the designation symbol on a screen.

In an embodiment of the present invention, the first decoding process searched out the designation symbol from a loop up table according to the codeword corresponding to the designation symbol. By analyzing the codeword corresponding to the designation symbol, a plurality of information associated with display the designation symbol on a display region of the screen can be obtained. The designation symbol is filled on the display region according to the obtained information.

The present invention provides a display system of the OSD including an encoding module, a memory module and a decoding module. The encoding module compresses a plurality of symbols of the OSD into a plurality of codewords respectively according to a first encoding process, and establishes a codebook including a plurality of index values corresponding to the symbols, wherein the index values are address information of storing the codewords in the memory module. The memory module is coupled to the encoding module for storing the codewords and the codebook. The decoding module is coupled to the memory module for searching out a designation symbol of the symbols from a look up table according to an input command corresponding to the designation symbol, and performing a first decoding process corresponding to the first encoding process on the codeword corresponding to the designation symbol, which is searched out from the memory module according to the searched index value, for displaying the designation symbol on a screen.

In an embodiment of the present invention, the decoding module includes a searching unit, an analysis unit, and a filling unit. The searching unit searches out the designation symbol from the look up table according to the codeword corresponding to the designation symbol. The analysis unit coupled to the searching unit analyzes the codeword corresponding to the designation symbol for obtaining a plurality of information associated with displaying the designation symbol on a display region of the screen. The filling unit coupled to the analysis unit fills the designation symbol on the display region according to the obtained information.

The present invention can save the storage space of the memory module, used for storing the OSD data, by compressing the OSD data, and thereby reduce the fabrication cost of the memory module. In addition, the address information of storing the codewords in the memory module is established in the codebook so that the address of the OSD data stored in the memory module can be known by searching the index values of the codebook for increasing the efficiency of displaying the OSD data.

In order to make the features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flow chart of a display method of an on screen display (OSD) according to an embodiment of the present invention.

FIG. 2A is a schematic diagram of a first encoding process according to an embodiment of the present invention.

FIG. 2B is a schematic diagram of a symbol of the OSD according to an embodiment of the present invention.

FIG. 3 is a schematic diagram of a display system of the OSD according to an embodiment of the present invention.

### DESCRIPTION OF THE EMBODIMENTS

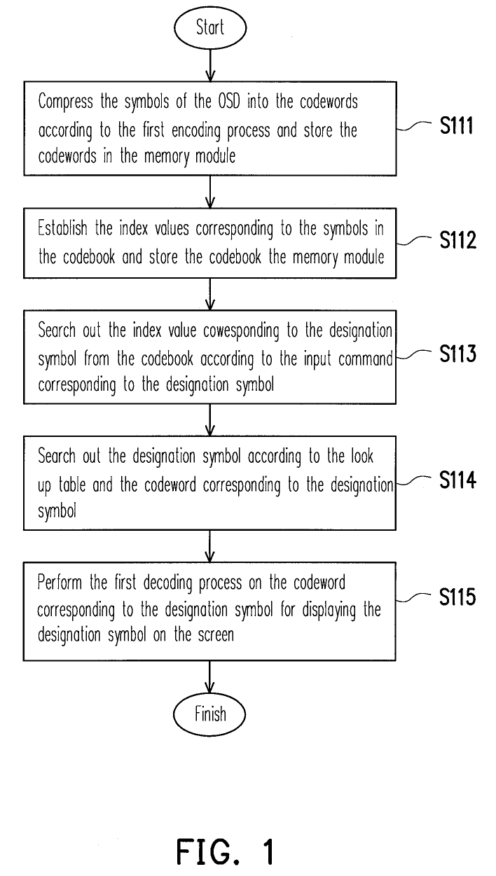

FIG. 1 is a flow chart of a display method of an on screen display (OSD) according to an embodiment of the present invention. Referring to FIG. 1, since display data of the OSD is considerable large, in step S111, the embodiment of the present invention performs a first encoding process on a plurality of symbols of the OSD for compressing the symbols into a plurality of codewords respectively, and storing the codewords in a memory module. As a result, by compression, the storage space of the memory module for storing the OSD data can be saved.

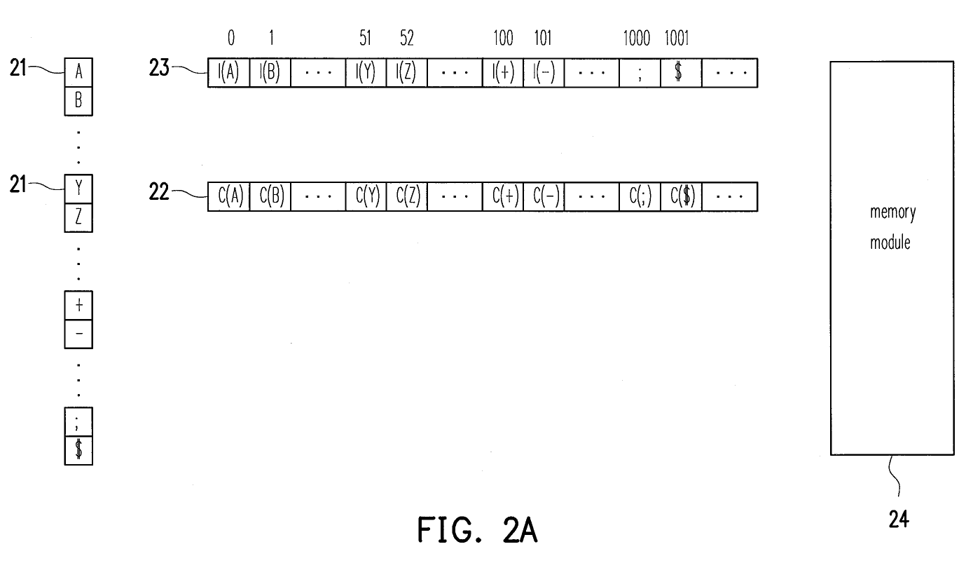

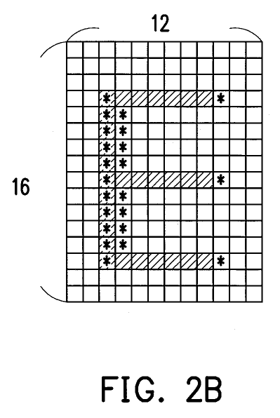

FIG. 2A is a schematic diagram of a first encoding process according to an embodiment of the present invention. Referring to FIG. 2A, the symbols 21 of the OSD, for example, are letters in English alphabet, mathematic symbols and punctuation marks. Taking the letter “E” as an example, as shown in FIG. 2B, the letter “E” can be represented by a binary code under a preset format, e.g. 12×16, wherein each white pixel and each black pixel of the letter “E” are respectively represented by “0” and “1”, so that data of the uncompressed letter “E” includes 12×16 bits. Since the neighbor pixels are more probable to have same color, the embodiment of the present invention utilizes a run length coding (RLC) to compress the symbols 21 of the OSD according to a standard T.4 specified by Consultative Committee for International Telegraph and Telephone (CCITT), or called G3. For example, the letter “E” can be represented by (color, length), and by raster scanning, the 12×16 bits of the letter “E” are encoded into (white, 38), (7), (5), (1), and etc., wherein only a initial color (i.e. white) is encoded herein. Therefore, the codeword obtained by compressing the symbol are the bits composed of these lengths (i.e. 38, 7, 5, 1 and etc).

In addition, the embodiment of the present invention can also utilize a modified Huffman (MH) coding to compress the symbols 21 of the OSD. For example, the said length is further represented by a quotient and a remainder obtained by dividing the length by a fix divisor, e.g. 38=64×0+38. For the same color, the quotient and the remainder associated with the length is encoded by Huffman coding so as to obtain the codeword corresponding to the symbol.

The said run length coding and the modified Huffman coding are one-dimension encoding process. In the G3 compression specification, a modified relative element address designate (modified READ, MR) coding, which is two-dimension encoding process, can be performed to compress the symbols 21 of the OSD. For example, referring to FIG. 2B, locations of pixels in the 4^{th} row, where the color is changed to differ from the previous pixel, are designated by “*”, i.e. the pixels in the 3^{rd} and the 10^{th} columns as for the 4^{th} row. In addition, locations of pixels in the 5^{th} row, where the color is changed to differ from the previous pixel, are designated by “*”, i.e. the pixels in the 3^{rd} and the 4^{th} columns as for the 5^{th} row. The designated pixels are called transition pixels. Since the lengths corresponding to each color in the currently processed row can be derived from the locations of the transition pixels in the neighbor rows, the modified READ coding defines a plurality of parameters associated with the locations of the transition pixels, and these parameters are useful when performing a decoding process. People ordinarily skilled in the art should know the said encoding process associate with VLC, MH coding, or Modified READ coding, so the detail is not iterated.

After the first encoding process, the symbols 21 of the OSD are compressed into the codewords and the codewords are stored in the memory module 24, wherein the memory module 24, for example, is read only memory (ROM). Referring to FIG. 2A, a data stream 22 includes the codewords C(A), C(B), . . . corresponding to the symbols 21. In the meanwhile, in step S112, the address information of storing the codewords in the memory module 24 (i.e. index values) are established in a codebook 23, and the codebook 23 is stored in the memory module 24, so that the time for searching out the codeword corresponding to the symbol 21 from the memory module 24 can be reduced. Referring to FIG. 2A, the codebook 23 includes the index values I(A)=0, I(B)=1, . . . corresponding to the symbols 21. In the embodiment of the present invention, a second encoding process, e.g. variable length coding (VLC), can be performed on the codebook 23 for compressing the codebook 23 in the memory module 24 so as to reduce the needed storage space of the memory module 24.

When displaying a designation symbol of the symbols, e.g. the letter “E”, on the screen, in step S113, the index value corresponding to the designation symbol is searched out from the codebook 23 stored in the memory module 24 according to an input command corresponding to the designation symbol. And then, in step S114, the codeword corresponding to the designation symbol is retrieved from the memory module 24 according to the searched index value. Next, in step S115, a decoding process corresponding to the first encoding process is performed on the codeword corresponding to the designation symbol for obtaining the designation symbol and displaying the designation symbol on the screen.

In the decoding process corresponding to the first encoding process, the designation symbol is searched out according to a look up table and the codeword-corresponding to the designation symbol, wherein the look up table is constructed according to a symbol-to-codeword mapping table during the first encoding process. By analyzing the codeword corresponding to the designation symbol, a plurality of information are obtained, such as a beginning location and an end location of the designation symbol filled on a display region of the screen, a length of the designation symbol, and a plurality of parameters associated with the decoding process corresponding to the first encoding process. Therefore, the designation symbol is filled on the display region of the screen for displaying the designation symbol.

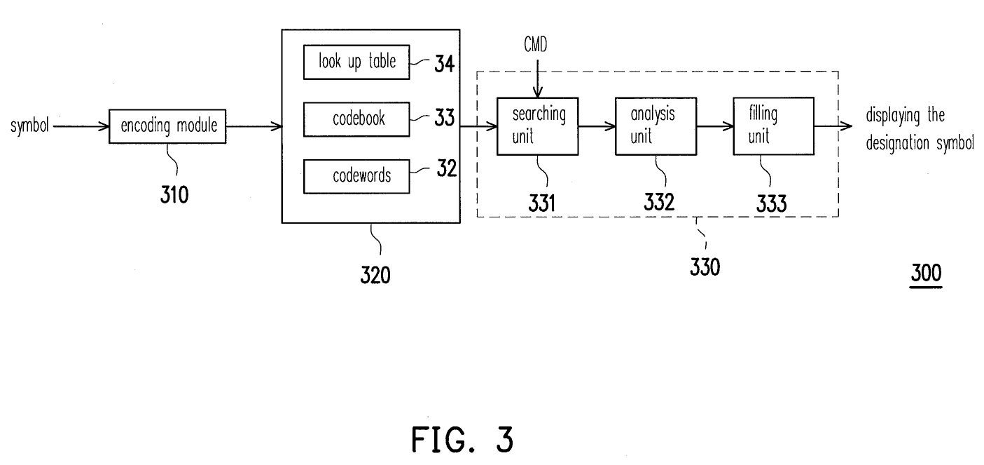

FIG. 3 is a schematic diagram of a display system of the OSD according to an embodiment of the present invention. Referring to FIG. 3, a display system 300 includes an encoding module 310, a memory module 320 and a decoding module 330. The encoding module 310 compresses the symbols of the OSD into the codewords according to the first encoding process, such as run length coding, modified Huffman coding, or modified relative element address designate coding, and the codewords are stored in the memory module 320. In addition, the encoding module 310 establishes the index values corresponding to the symbols in the codebook 33, which are the address information of storing the codewords in the memory module 320, and then the codebook 33 is stored in the memory module 320. In the embodiment of the present invention, the second encoding process e.g. variable length coding, is performed on the codebook 33 by the encoding module 310 for compressing the codebook 33. During the first encoding process, the look up table 34 used for post decoding process is also stored in the memory module 320.

The decoding module 330 coupled to the memory module 320 includes a searching unit 331, an analysis unit 332, and filling unit 333. The searching unit 331 searches the index value corresponding to the designation symbol from the memory module 320 according to the input command corresponding to the designation symbol, and fetches the codeword corresponding to the designation symbol from the memory module 320 according to the searched index value. If the codebook 33 is also compressed in the memory module 320, the decoding module 330 should perform the corresponding decoding process on the codebook 33 for searching the index value corresponding to the designation symbol. After obtaining the codeword corresponding to the designation symbol, the searching unit 331 further searches out the designation symbol according to the look up table 34 and the codeword corresponding to the designation symbol. The analysis unit 332 coupled to the searching unit 331 analyzes the codeword corresponding to the designation symbol and thereby obtains the information of displaying the designation symbol on the display region of the screen. Therefore, the filling unit 333 fills the designation symbol on the display region according to the information obtained by analyzing.

In summary, the said embodiments can save the storage space of the memory module by compressing the symbols of the OSD into the codewords and compressing the codebook. Since the address information of storing the codewords in the memory module are included in the codebook, time for searching the codewords from the memory during the decompressed process can be shorten for increasing the operation efficiency of display the OSD data.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. A display method of an on screen display (OSD), comprising:
compressing a plurality of symbols of the OSD into a plurality of codewords according to a first encoding process, respectively, and storing the codewords in a memory module;
establishing a codebook in the memory module, wherein the codebook comprising a plurality of index values respectively corresponding to the symbols, and the index values are address information of storing the codewords in the memory module;
searching out the index value corresponding to a designation symbol of the symbols from the codebook according to an input command corresponding to the designation symbol;
searching out the codeword corresponding to the designation symbol from the memory module according to the searched index value; and
performing a first decoding process corresponding to the first encoding process on the codeword corresponding to the designation symbol, and displaying the designation symbol on a screen.

2. The display method as claimed in claim 1, further comprising:
performing a second encoding process on the codebook for compressing and storing the codebook in the memory module; and
performing a second decoding process corresponding to the second encoding process on the compressed codebook for searching out the index value corresponding to the designation symbol.

3. The display method as claimed in claim 1, wherein the second encoding process comprises a variable length coding (VLC).

4. The display method as claimed in claim 1, wherein the first decoding process comprises:
searching out the designation symbol according to a look up table and the codeword corresponding to the designation symbol;
analyzing the codeword corresponding to the designation symbol for obtaining a plurality of information associated with displaying the designation symbol on a display region of the screen; and
filling the designation symbol on the display region according to the obtained information.

5. The display method as claimed in claim 4, wherein the obtained information comprise a beginning location and an end location of the designation symbol filled on the display region, a length of the designation symbol, and a plurality of parameters associated with the first decoding process.

6. The display method as claimed in claim 1, wherein the first encoding process comprises a run length coding (RLC).

7. The display method as claimed in claim 6, wherein the first encoding process further comprises a modified Huffman (MH) coding.

8. The display method as claimed in claim 6, wherein the first encoding process further comprises a modified relative element address designate (MR) coding.

9. A display system of an on screen display (OSD), comprising:
an encoding module, for compressing a plurality of symbols of the OSD into a plurality of codewords according to a first encoding process, respectively, and establishing a codebook comprising a plurality of index values corresponding to the symbols;
a memory module, coupled to the encoding module for storing the codewords and the codebook, wherein the index values are address information of storing the codewords in the memory module; and
a decoding module, coupled to the memory module for searching out the index value corresponding to a designation symbol of the symbols from the codebook according to an input command corresponding to the designation symbol, searching out the codeword corresponding to the designation symbol from the memory module according to the searched index value, and performing a first decoding process corresponding to the first encoding process on the codeword corresponding to the designation symbol so as to display the designation symbol on a screen.

10. The display system as claimed in claim 9, wherein the encoding module performs a second encoding process on the codebook for compressing and storing the codebook in the memory module, and the decoding module performs a second decoding process corresponding to the second encoding process for searching out the index value corresponding to the designation symbol.

11. The display system as claimed in claim 10, wherein the second encoding process comprises a variable length coding (VLC).

12. The display system as claimed in claim 9, wherein the decoding module comprises:
a searching unit, searching out the designation symbol according to a look up table and the codeword corresponding to the designation symbol;
an analysis unit, coupled to the searching unit for analyzing the codeword corresponding to the designation symbol and thereby obtaining a plurality of information associated with display the designation symbol on a display region of the screen; and
a filling unit, coupled to the analysis unit for filling the designation symbol on the display region according to the obtained information.

13. The display system as claimed in claim 12, wherein the obtained information comprise a beginning location and an end location of the designation symbol filled on the display region, a length of the designation symbol, and a plurality of parameters associated with the first decoding process.

14. The display system as claimed in claim 9, wherein the first encoding process comprises a run length coding (RLC).

15. The display system as claimed in claim 14, wherein the first encoding process further comprises a modified Huffman (MH) coding.

16. The display system as claimed in claim 14, wherein the first encoding process further comprises a modified relative element address designate (MR) coding.
